(19) United States
(12) Patent Application Publication
(10) Pub. No.: US 2013/0107881 A1
(43) Pub. Date: May 2, 2013

(54) Distributed Address Resolution Service for Virtualized Networks

(71) Applicants: Katherine Barabash, Haifa (IL); Rami Cohen, Haifa (IL); Benny Rochwerger, Zichron Yaakov (IL)

(72) Inventors: Katherine Barabash, Haifa (IL); Rami Cohen, Haifa (IL); Benny Rochwerger, Zichron Yaakov (IL)

(73) Assignee: INTERNATIONAL BUSINESS MACHINES CORPORATION, Armonk, NY (US)

(21) Appl. No.: 13/459,886

(22) Filed: Apr. 30, 2012

Related U.S. Application Data
(63) Continuation of application No. 13/287,250, filed on Nov. 2, 2011.

(51) Int. Cl. H04L 12/56

(52) U.S. Cl. 370/389

(57) ABSTRACT

An approach is provided in which a local module receives an egress data packet and extracts a virtual IP address from the data packet that corresponds to a virtual network endpoint that generated the data packet. The local module identifies an endpoint address entry corresponding to the virtual network endpoint, and determines that the endpoint address entry fails to include the extracted virtual IP address. As a result, the local module updates the endpoint address entry with the extracted virtual IP address and notifies a distributed policy service of the endpoint address entry update.

### RELATED APPLICATION

This application is a continuation of U.S. application Ser. No. 13/287,250, filed Nov. 2, 2011, titled “Distributed Address Resolution Service for Virtualized Networks,” and having the same inventor as the above-referenced application.

### BACKGROUND

The present disclosure relates to a distributed address resolution service for virtualized networks. More particularly, the present disclosure relates to a distributed policy service obtaining address information and providing address resolution services to virtual network endpoints executing within an overlay network environment.

Server virtualization technology enables hardware server consolidation such that a multitude of virtual network endpoints (e.g., virtual machines) may be deployed onto a single physical server. This technology allows a system administrator to move virtual network endpoints to different servers as required, such as for security-related issues or load balancing purposes.

Many network environments rely on an Address Resolution Protocol (ARP) to discover physical address mappings of new or moved virtual network endpoints. Address Resolution Protocol (ARP) is a telecommunications protocol used for resolving network layer addresses into link layer addresses. The Address Resolution Protocol is a broadcast request and reply protocol that is communicated within the boundaries of a single network (does not route across inter-network nodes).

### BRIEF SUMMARY

According to one embodiment of the present disclosure, an approach is provided in which a local module receives an egress data packet and extracts a virtual IP address from the data packet that corresponds to a virtual network endpoint that generated the data packet. The local module identifies an endpoint address entry corresponding to the virtual network endpoint, and determines that the endpoint address entry fails to include the extracted virtual IP address. As a result, the local module updates the endpoint address entry with the extracted virtual IP address and notifies a distributed policy service of the endpoint address entry update.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a diagram showing a distributed policy service resolving an overlay address resolution request;

FIG. 2A is a diagram showing an example of an overlay address resolution request that a local module sends to a distributed policy service to resolve an address resolution request that the local module receives from a virtual network endpoint;

FIG. 2B is a diagram showing an example of an overlay address resolution reply;

FIG. 2C is an exemplary diagram showing a local endpoint table;

FIG. 3 is a flowchart showing steps taken in a local module collecting endpoint address information pertaining to hosted virtual network endpoints, and providing the address information to a distributed policy service;

FIG. 4 is a flowchart showing steps taken in a local module monitoring egress data traffic and updating endpoint address entries accordingly;

FIG. 5 is a flowchart showing steps taken in a local module querying a distributed policy service to resolve an address resolution request received from a hosted/supported virtual network endpoint;

FIG. 6 is a flowchart showing steps taken in a distributed policy service resolving an overlay address resolution request received from a local module executing on a host system;

FIG. 7 is a flowchart showing steps taken in a distributed policy service resolving partial endpoint address entries that are devoid of a virtual IP address in order to resolve an overlay address resolution request that was received from a local module;

FIG. 8 is a flowchart showing steps taken in a distributed policy service storing partial endpoint address entries that are devoid of a physical host address;

FIG. 9 is a flowchart showing steps taken in a distributed policy service receiving virtual network endpoint address update information from a local module;

FIG. 10 is a diagram showing a distributed policy service accessing a virtual domain endpoint table to resolve an overlay address resolution request;

FIG. 11 is a diagram showing virtual network abstractions that are overlayed onto a physical network space;

FIG. 12 is a block diagram of a data processing system in which the methods described herein can be implemented; and

FIG. 13 provides an extension of the information handling system environment shown in FIG. 12 to illustrate that the methods described herein can be performed on a wide variety of information handling systems which operate in a networked environment.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The following detailed description will generally follow the summary of the disclosure, as set forth above, further explaining and expanding the definitions of the various aspects and embodiments of the disclosure as necessary.

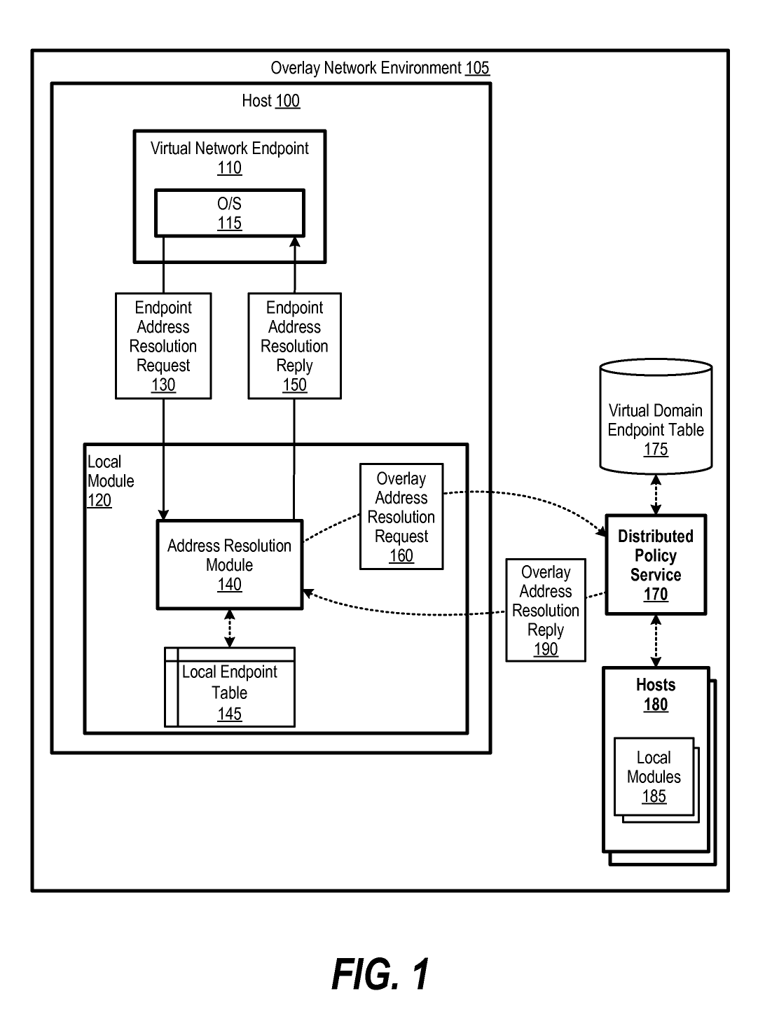

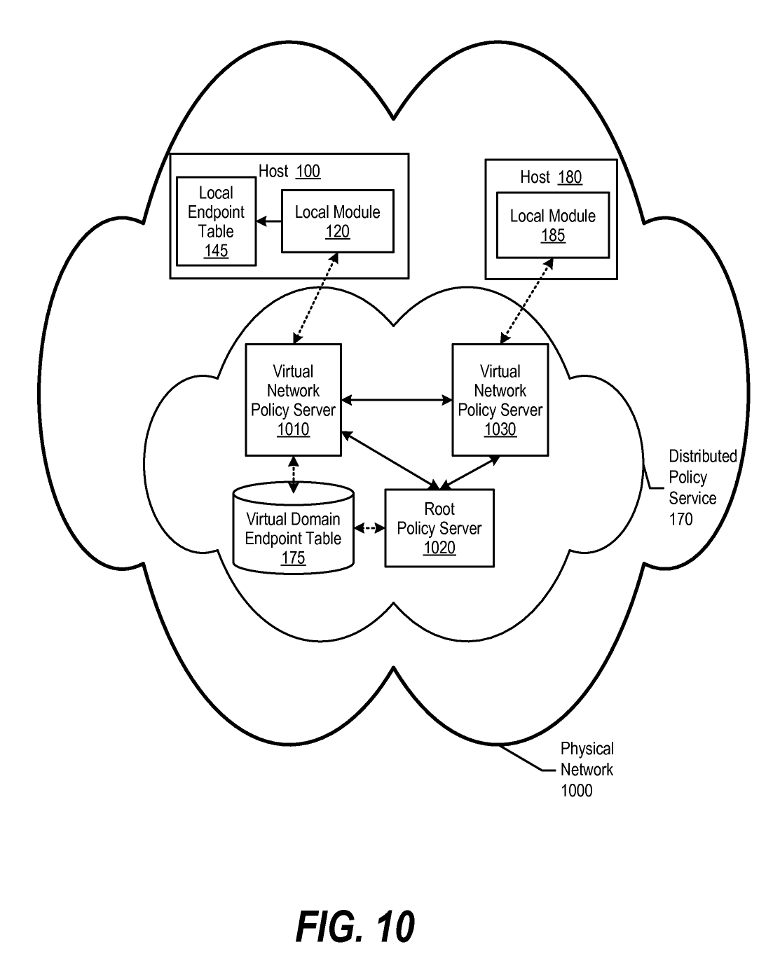

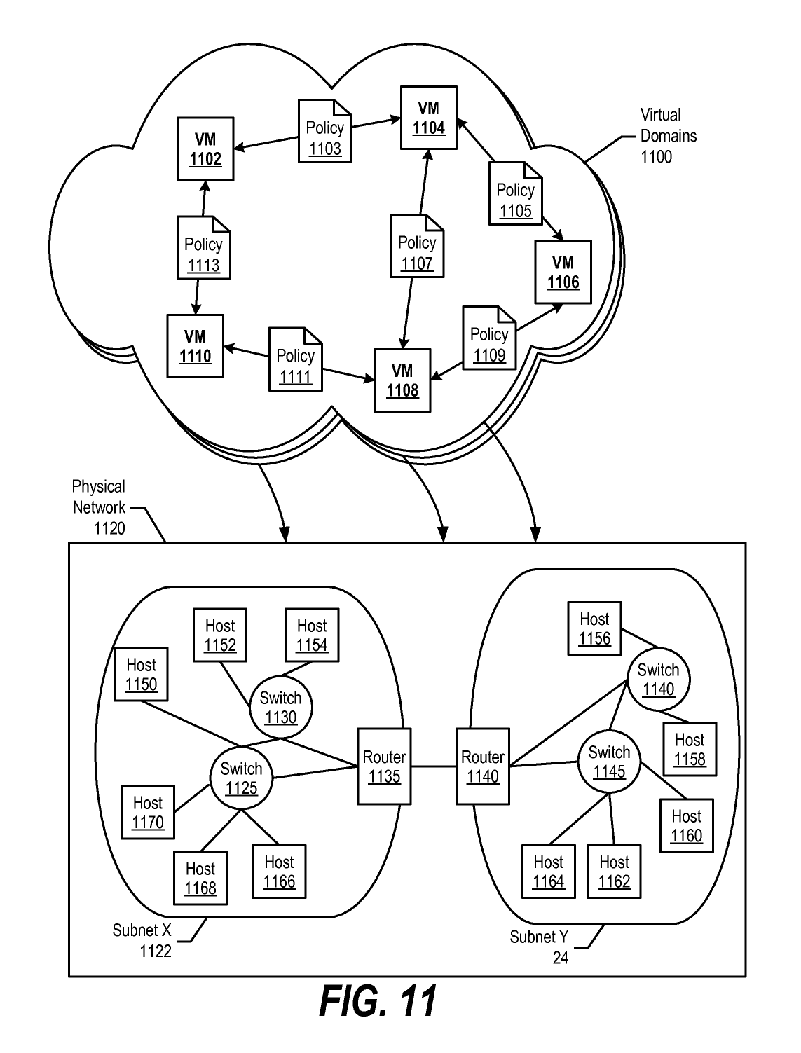

FIG. 1 is a diagram showing a distributed policy service resolving an overlay address resolution request. Distributed policy service 170 provides a distributed address resolution service that is utilized in a multi-tenant virtualized environment, which reduces the amount of broadcast address resolution protocol (ARP) packets in a computer network. The distributed address resolution service decouples an overlay network environment (virtual environment) from an underlying physical network infrastructure, thus increasing system administrator flexibility. In one embodiment, such decoupling allows an administrator to allocate the same virtual IP addresses to different virtual network endpoints (virtual machines) that belong to different tenants. In another embodiment, the decoupling allows the administrator to modify the underlying physical network infrastructure without affecting the overlay network environment (see FIGS. 10-11 and corresponding text for further details).

Overlay network environment 105 includes host 100, distributed policy service 170, and hosts 180. Host 100 includes virtual network endpoint 110 and local module 120. Virtual network endpoint 110 includes operating system 115, which manages destination address resolutions pertaining to data packets generated by virtual network endpoint 110. When a situation arises in which virtual network endpoint 110 requires an address resolution, virtual network endpoint 110's operating system 115 transmits endpoint address resolution request 130, which address resolution module 140 intercepts within local module 120.

Address resolution module 140 accesses local endpoint table 145 for an endpoint address entry (table entry) corresponding to endpoint address resolution request 130. If address resolution module 140 does not locate a corresponding endpoint address entry in local endpoint table 145, address resolution module 140 queries distributed policy service 170 via overlay address resolution request 160. Using a hierarchical structure, distributed policy service 170 accesses virtual domain endpoint table 175 to locate a corresponding endpoint address entry. Virtual domain endpoint table 175 includes complete endpoint address entries (includes values for each field) and may also include partial endpoint address entries (includes a partial list of values) for virtual network endpoints that operate within the virtual domain managed by distributed policy service 170. In one embodiment, distributed policy service 170 may manage multiple virtual domain endpoint tables 175, each supporting different domains. In this embodiment, distributed policy service 170 looks up address resolutions in the context of the virtual domain that corresponds to the requesting source virtual network endpoint.

If distributed policy service 170 identifies a table entry with the corresponding address resolution information, distributed policy service 170 sends overlay address resolution reply 190 back to address resolution module 140 with the necessary information, which address resolution module 140 updates in local endpoint table 145. In turn, address resolution module 140 responds to endpoint address resolution request 130 by sending endpoint address resolution reply 150, which includes the address resolution information. As a result, the physical computer network is not inundated with endpoint address resolution requests from the multitude of virtual network endpoints.

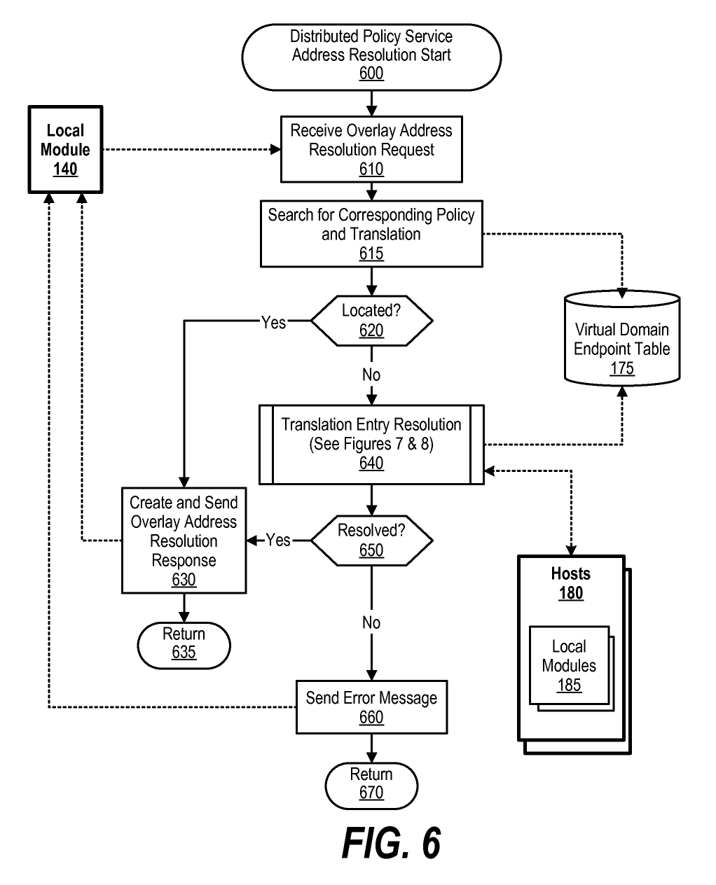

In one embodiment, distributed policy service 170 proceeds through a series of steps to query hosts 180 via local modules 185 in order to identify destination virtual network endpoint address information pertaining to overlay address resolution request 160 (see FIGS. 6-8 and corresponding text for further details). Once located, distributed policy service 170 updates virtual domain table 175 and sends the address information via overlay address resolution reply 190 to address resolution module 140.

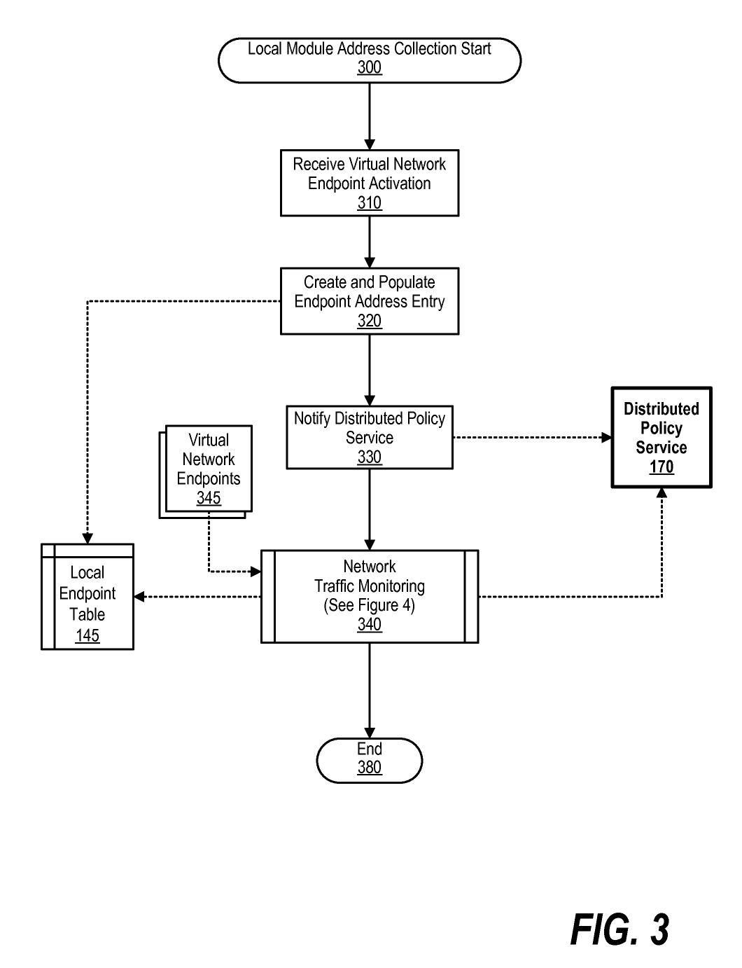

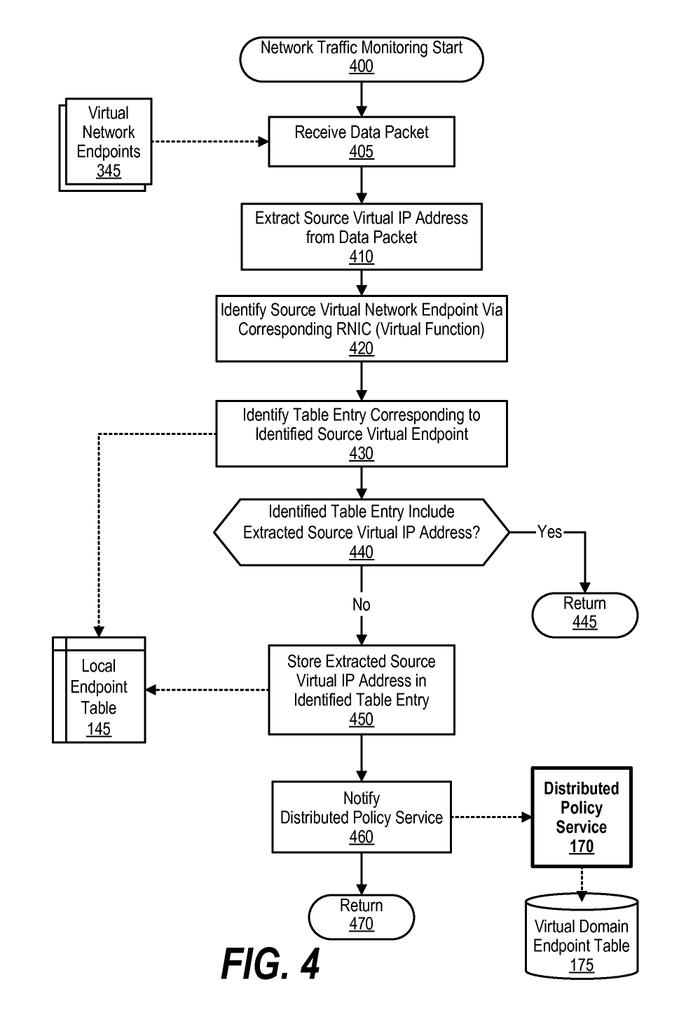

In another embodiment, each local module maintains a local endpoint table of their locally hosted virtual network endpoints. When an endpoint is activated, address resolution module 140 populates local endpoint table 145 with known information and informs distributed policy service 175. In some cases, the virtual network endpoint's virtual IP address is unknown. In these cases, the local module may monitor network traffic in order to identify the virtual network's virtual IP address and report it to distributed policy service 170 (see FIGS. 3-4 and corresponding text for further details).

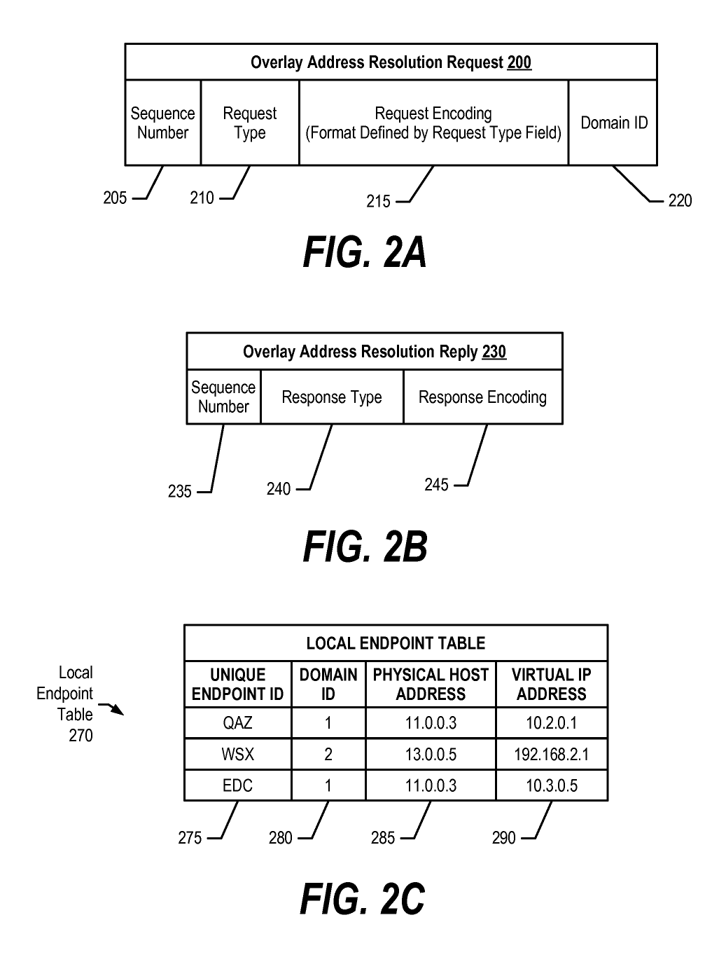

FIG. 2A is a diagram showing an example of an overlay address resolution request that a local module sends to a distributed policy service to resolve an address resolution request received from a virtual network endpoint. Overlay address resolution request 200 includes fields 205-220. As those skilled in the art can appreciate, an overlay address resolution request may include more or less fields than what is shown in FIG. 2A. Field 205 includes a request sequence number that the distributed policy service includes in a return response to the local module so the local module correlates the response with the corresponding request (see FIG. 2B and corresponding text for further details).

Field 210 includes a request type that identifies the type of requested address, such as IPv4, IP6, etc, and also identifies the encoding of field 215. Field 215 includes request encoding that includes the destination virtual network endpoint's virtual IP address, and may also include the virtual IP of the source (requesting) virtual network endpoint.

In one embodiment, the distributed policy service may be configured to allow/disallow address resolution to occur for certain addresses and/or certain domains. Using request type 210 and request encoding 215 allows an administrator to modify the request format as the system evolves in order to support sending additional information in overlay address resolution request 200. For example, the administrator may need to support new client address resolution protocol standards and want to piggy back additional functionality on top of address resolution messages. Field 220 includes a domain identifier that corresponds to the source virtual network endpoint that requested an address resolution.

FIG. 2B is a diagram showing an example of an overlay address resolution reply. A distributed policy service sends overlay address resolution reply 230 to a local module in response to receiving overlay address resolution request 200 shown in FIG. 2A.

Overlay address resolution reply 230 includes fields 235-245. As those skilled in the art can appreciate, an overlay address resolution reply may include more or less fields than what is shown in FIG. 2B. Field 235 includes a sequence number that was included in the address resolution request received at the distributed policy service (see FIG. 2A and corresponding text for further details). This allows the host module to correlate the address resolution response with its address resolution request.

Fields 240 and 245 include a response type and a response encoding, respectively, to support inclusion of different reply formats in overlay address resolution reply 230. Response encoding 245 includes a physical IP address of the address resolution module hosting (supporting) the destination virtual network endpoint (which is cached by the requesting module and used later to encapsulate packets sent by the source virtual network endpoint to the destination virtual network endpoint). In one embodiment, response encoding 245 may include a MAC address of the destination virtual network.

FIG. 2C is an exemplary diagram showing a local endpoint table. Local endpoint table 270 includes columns 275-290. Column 275 includes a unique endpoint identifier for each virtual endpoint. Column 280 includes a virtual domain identifier to which the virtual network endpoint belongs. Column 285 includes a physical host address that corresponds to the host server that hosts the virtual network endpoint. And, column 290 includes a virtual IP address for the corresponding virtual network endpoints. In one embodiment, local endpoint table may include other fields, such as a MAC address of the virtual network endpoint, the identity of an attached virtual interface, etc.

FIG. 3 is a flowchart showing steps taken in a local module collecting endpoint address information pertaining to hosted virtual network endpoints, and providing the address information to a distributed policy service. A local module, such as address resolution module 140 shown in FIG. 1, supports one or more virtual network endpoints that execute on a host system (e.g., virtual network endpoint 115 executing on host 100).

Processing commences at 300, whereupon the local module receives a virtual network endpoint activation at step 310 (e.g., from an administrator or hypervisor executing on the host system). The local module creates an endpoint address entry in local endpoint table 145 and populates the endpoint address entry with available endpoint address information (step 320). In one embodiment, each endpoint address entry includes a field for an endpoint identifier, a virtual IP address, and a virtual domain ID.

In one embodiment, an endpoint activation message may include enough address information to populate the endpoint address entry in its entirety. In another embodiment, some address information may not be known at activation, such as the virtual network endpoint's virtual IP address, in which case the local module partially populates the endpoint address entry with available address information. In yet another embodiment, the local module may send an inverse ARP request to a virtual network endpoint in order to obtain the virtual network endpoint's address information, such as its virtual IP address.

At step 330, the local module sends a notification to distributed policy service 170 of the virtual network endpoint and endpoint address information. In turn, distributed policy service 170 creates and populates a global endpoint address table that distributed policy service 170 maintains.

The local module monitors network traffic (e.g., egress data packets generated by virtual network endpoints 345) to detect unlogged address information. Once detected, the local module updates local endpoint table 145 and notifies distributed policy service 170 accordingly (pre-defined process block 340, see FIG. 4 and corresponding text for further details). Local module processing ends at 380.

In one embodiment, the local module sends all address information to distributed policy service 170 each time it updates its local endpoint address table, such as when a virtual network endpoint is reconfigured with a new virtual IP address.

FIG. 4 is a flowchart showing steps taken in a local module monitoring egress data traffic and updating endpoint address entries accordingly. Processing commences at 400, whereupon a local module receives an egress data packet from one of virtual network endpoints 345 that traverses through the local module at step 405. The local module extracts a source virtual IP address from the data packet at step 410, which corresponds to the virtual network endpoint that sent the egress data packet.

At step 420, the local module identifies the source virtual network endpoint based upon the RNIC through which the egress data packet traversed. In one embodiment, the local module identifies the source virtual network endpoint ID, a virtual domain ID, and may also identify a source MAC address and/or a virtual group ID.

Next, the local module identifies a table entry in local endpoint table 145 that corresponds to the source virtual network endpoint (step 430). In one embodiment, the local endpoint table 145 may be segregated based on domain ID's, in which case the local module utilizes an extracted domain ID to assist in the identification of the corresponding table entry.

The local module determines whether the identified table entry includes a virtual IP address that matches the extracted source virtual IP address (decision 440). If the table entry includes a source virtual IP address that matches the extracted source virtual IP address, decision 440 branches the “Yes” branch, whereupon processing returns at 445.

On the other hand, if the table entry does not include a matching source virtual IP address (e.g., either doesn't include an source virtual IP address or includes a non-matching virtual IP address), decision 440 branches to the “Yes” branch, whereupon the local module stores the extracted source endpoint virtual IP address in the identified table entry located in local endpoint table 145 (step 450). In order to maintain continuity across the virtual domain, the local module sends a notification to distributed policy service 170 of the change at step 460 (distributed policy service 170 updates virtual domain endpoint table 175), and local module processing returns at 470.

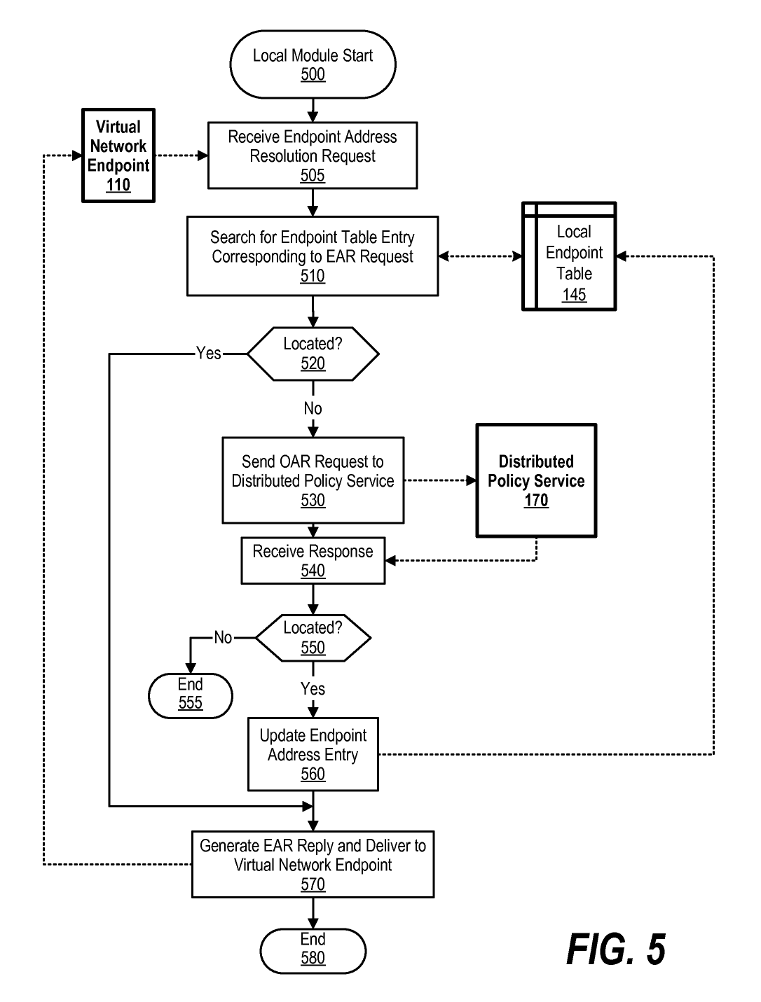

FIG. 5 is a flowchart showing steps taken in querying a distributed policy service to resolve an address resolution request received from a virtual network endpoint. Processing commences at 500, whereupon a local module executing on a host system receives an endpoint address resolution request from virtual network endpoint 110, which includes a destination virtual IP address corresponding to a destination virtual network endpoint (step 505).

In one embodiment, the endpoint address resolution request adheres to an address resolution protocol (ARP), such as a standard network address resolution protocol described in RFC826 or a “neighbor discovery protocol” utilized in IPv6.

At step 510, the local module accesses local endpoint table 145 to search for a complete endpoint address entry that corresponds to the destination virtual IP address. Complete endpoint address entries include a virtual IP address and a physical host address that corresponds to the host that executes a virtual network corresponding to the virtual IP address. The physical host address may be a MAC address or an IP address that corresponds to the host system.

If the local module finds a complete endpoint address entry that corresponds to the destination IP address, decision 520 branches to the “Yes” branch, whereupon the local module generates an endpoint address resolution reply, which includes the physical host address, and provides the endpoint address resolution reply to virtual network endpoint 110 at step 570.

On the other hand, if the local module does not locate a corresponding complete endpoint address entry, decision 520 branches to the “No” branch, whereupon the local module sends an overlay address resolution request to distributed policy service 170 (step 530). The overlay address resolution request includes the destination virtual IP address that was included in the endpoint address resolution request and also includes a domain ID (see FIG. 2A and corresponding text for further details).

The distributed policy service checks a global endpoint address table and, if a complete endpoint address entry is not located, the distributed policy service proceeds through a series of steps to resolve the overlay address resolution request (see FIGS. 6-8 and corresponding text for further details).

The local module receives an overlay address resolution reply at step 540, and a determination is made as to whether distributed policy service 170 resolved the overlay address resolution request and provided a physical host address in the overlay address resolution reply (decision 550). If distributed policy service 170 did not resolve the overlay address resolution request, decision 550 branches to the “No” branch, whereupon local module processing ends at 555. In one embodiment, the local module sends an error response to virtual network endpoint 110, indicating that its endpoint address resolution request was not resolved.

On the other hand, if distributed policy service 170 resolved the overlay address resolution request, decision 550 branches to the “Yes” branch, whereupon the local module updates the corresponding endpoint address entry in local endpoint table 145 (step 560). At step 570, the local module generates an endpoint address resolution reply, which includes the physical host address, and sends the endpoint address resolution reply to virtual network endpoint 110. Local module processing ends at 580.

FIG. 6 is a flowchart showing steps taken in a distributed policy service resolving an overlay address resolution request received from a local module executing on a host system. Distributed policy service overlay address resolution request processing commences at 600, whereupon the distributed policy service receives an overlay address resolution request from address resolution module 140 at step 610. Address resolution module 140, in FIG. 5, determined that a complete endpoint address entry did not exist in its local endpoint address table, which prompted address resolution module 140 to send the overlay address resolution request to the distributed policy service.

The distributed policy service accesses virtual domain endpoint table 175 and searches for a complete endpoint address entry that corresponds to the endpoint specification included in the overlay address resolution request at step 615 (e.g., destination virtual IP address and domain ID). If the distributed policy service identifies a corresponding complete endpoint address entry, decision 620 branches to the “Yes” branch, whereupon the distributed policy service creates an overlay address resolution reply, which includes a corresponding physical host address, and sends the overlay address resolution reply to address resolution module 140 at step 630. Distributed policy service processing returns at 635.

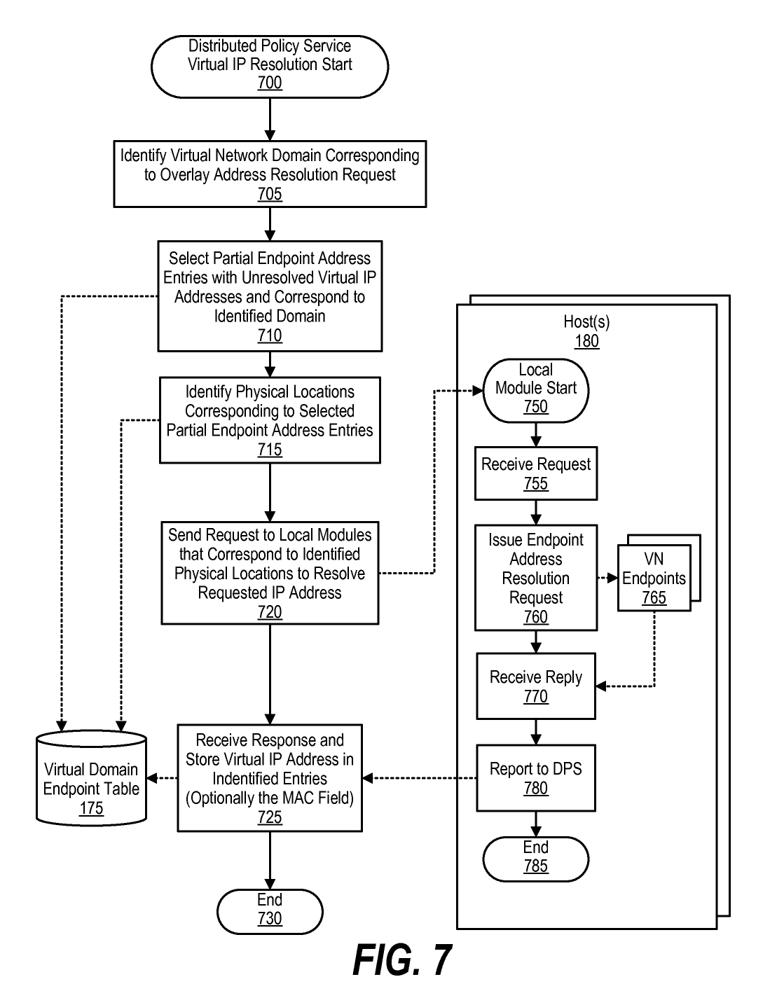

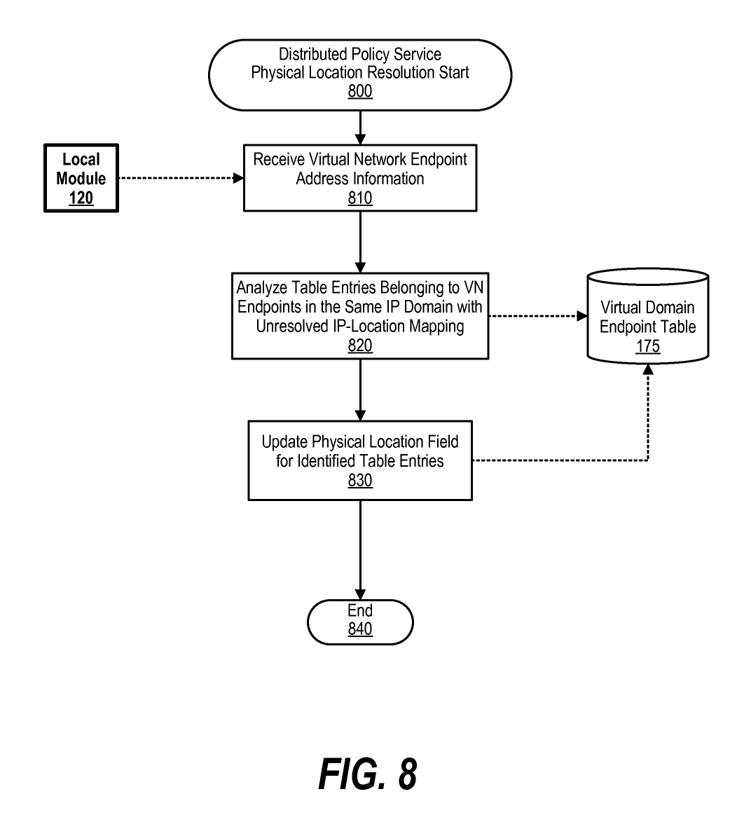

On the other hand, if the distributed policy service does not locate a corresponding complete endpoint address entry, decision 620 branches to the “No” branch, whereupon the distributed policy service proceeds through a series of steps to resolve the overlay address resolution request, such as querying local modules 185 executing on hosts 180 in order to resolve partial endpoint address entries that are included in the global endpoint address table. In one embodiment, a partial endpoint address entry is an entry that includes a virtual IP address but does not include a physical host address (or vice versa) (pre-defined process block 640, see FIGS. 7, 8, and corresponding text for further details).

If the distributed policy service resolves the overlay address resolution request, decision 650 branches to the “Yes” branch, whereupon the distributed policy service creates an overlay address resolution reply (includes the physical host address) and sends the overlay address resolution reply to address resolution module 140 at step 630. On the other hand, if the distributed policy service does not resolve the overlay address resolution request, the distributed policy service sends an error message to address resolution module 140 at step 660, and returns at 670.

FIG. 7 is a flowchart showing steps taken in a distributed policy service resolving partial endpoint address entries that are devoid of a virtual IP address in order to resolve an overlay address resolution request that was received from a local module (see FIG. 6 and corresponding text for further details). In one embodiment, the distributed policy service resolves partial endpoint address entries for other reasons, such as when location and address data is required for overlay network policy resolutions.

Processing commences at 700, whereupon the distributed policy service identifies a virtual network domain that corresponds to the overlay address resolution request (step 705). The overlay address resolution request includes a virtual network domain identifier that corresponds to the source virtual network endpoint. Next, the distributed policy service selects partial endpoint address entries in virtual domain endpoint table 175 that correspond to the identified virtual network domain and include an unresolved virtual IP address (step 710). In one embodiment, the distributed policy service analyzes each endpoint address entry's domain ID field and virtual IP address field to perform the selection (see FIG. 2C and corresponding text for further details).

At step 715, the distributed policy service analyzes the selected partial endpoint address entries and identifies physical locations (e.g., physical host addresses) that are included in the selected partial endpoint address entries. FIG. 7 shows that hosts 180 correspond to the physical locations identified by the distributed policy service. The distributed policy service sends a request to local modules that reside on the identified physical locations to resolve the virtual IP address that was included in the overlay address resolution request (step 720). In one embodiment, when multiple virtual IP addresses are allowed per virtual network endpoint, a more conservative group of physical hosts are addressed in step 720.

In another embodiment, the request sent in step 720 is sent to local modules that are dedicated to a particular domain. For example, if a local module hosts virtual network endpoints belonging to different domains, the distributed policy service does not send a request to such modules because virtual network IP address belonging to a different domain may return a wrong virtual network endpoint identifier.

Local module processing commences at 750, whereupon one or more local module issue endpoint address resolution requests (e.g., ARPs) to their supported virtual network endpoints 765 at step 760. The local modules receive one or more replies from their supported virtual network endpoints 765 at step 770 and report their findings at step 780. Local module processing ends at 785.

The distributed policy service receives a local module's response at step 725, and updates the corresponding partial endpoint address entry accordingly (e.g., making the partial endpoint address entry a complete endpoint address entry). Distributed policy service processing ends at 730.

FIG. 8 is a flowchart showing steps taken in a distributed policy service storing partial endpoint address entries that are devoid of a physical host address (see FIG. 6 and corresponding text for further details).

Processing commences at 800, whereupon the distributed policy service receives virtual network endpoint address information from local module 120 (step 810), such as by way of steps shown in FIG. 3. The virtual network endpoint address information includes a unique endpoint identifier and may include virtual IP address and a corresponding physical host address. In one embodiment, the distributed policy service may receive virtual network endpoint address information from a different source, such as a management tool.

At step 820, the distributed policy service analyzes partial endpoint address entries included in virtual domain endpoint table 175 that include virtual IP addresses belonging to the same subnet mask as the virtual IP address included in the virtual network address information.

Next, the distributed policy service updates the partial endpoint entries including virtual IP addresses with the physical host address that was included in the virtual network address information received from address resolution module 140. Processing ends at 840.

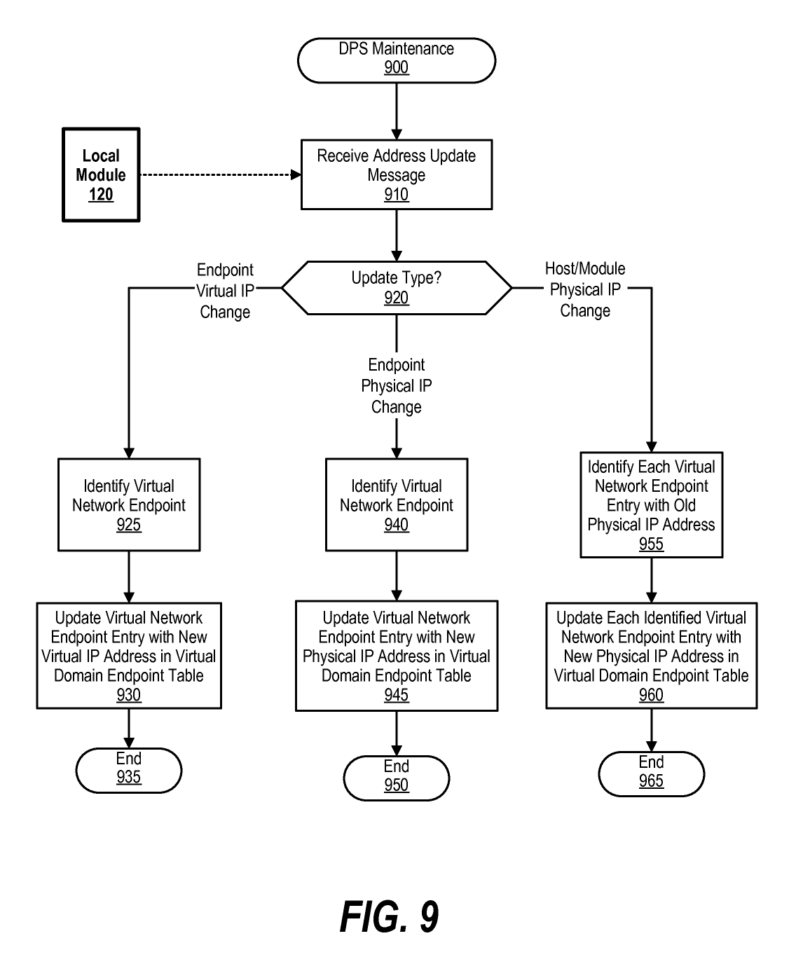

FIG. 9 is a flowchart showing steps taken in a distributed policy service receiving address update messages from a local module. In one embodiment, the distributed policy service may receive address update messages from other sources, such as a management tool.

Processing commences at 900, whereupon the distributed policy service receives an address update message from local module 120 at step 910. A determination is made as to whether the address update message corresponds to an endpoint virtual IP change, an endpoint physical IP change (e.g., due to a virtual machine migration), or a host/module physical IP change (e.g., due to physical host reconfiguration or failover) (decision 920).

If the address update message corresponds to an endpoint virtual IP address change, decision 920 branches to the “Endpoint Virtual IP Change” branch, whereupon the distributed policy service identifies the virtual network endpoint requiring the change (step 925) and, at step 930, the distributed policy service updates the corresponding virtual network endpoint entry in the virtual domain endpoint table with the new virtual IP address. Processing ends at 935.

On the other hand, if the address update message corresponds to an endpoint physical IP address change, decision 920 branches to the “Endpoint Physical IP Change” branch, whereupon the distributed policy service identifies the virtual network endpoint requiring the change (step 940) and, at step 945, the distributed policy service updates the corresponding virtual network endpoint entry in the virtual domain endpoint table with the new physical IP address. Processing ends at 950.

On the other hand, if the address update message corresponds to a host or module physical IP address change, decision 920 branches to the “Host/Module Physical IP Change” branch, whereupon the distributed policy service identifies each virtual network endpoint entry that includes the old physical IP address (step 955) and, at step 960, the distributed policy service updates each of the identified virtual network endpoint entries with the new host/local module physical IP address. Processing ends at 965.

FIG. 10 is a diagram showing a distributed policy service accessing a virtual domain endpoint table to resolve an overlay address resolution request. Address resolution module 140 sends an overlay address resolution request to distributed policy service 170 to resolve an address requested by a virtual network endpoint executing on host 100. Distributed policy service 170 includes virtual network policy server 1010, which is a local policy server that manages policies and physical path translations pertaining to the source system's overlay network (e.g., overlay network environment 105 shown in FIG. 1). In one embodiment, policy servers for different overlay networks are co-located and differentiate policy requests from different migration agents according to their corresponding overlay network identifier.

Distributed policy service 170 is structured hierarchically and, when virtual network policy server 1010 is not able to resolve the overlay address resolution request, virtual network policy server 1010 queries root policy server 1020 to resolve the address. In turn, root policy server 1020 accesses virtual domain endpoint table 175 and sends address information to virtual network policy server 1010, which sends it to address resolution module 140. In one embodiment, root policy server 1020 may send virtual network policy server 1010 a message to query virtual network policy server 1030, which manages other host systems than what local network policy server 1010 manages.

FIG. 11 is a diagram showing virtual network abstractions that are overlayed onto a physical network space. Virtual domains 1100 are part of an overlay network environment and include policies (e.g., policies 1103-1113) that provide an end-to-end virtual connectivity between virtual network endpoints (e.g., virtual machines 1102-1110). Each of virtual domains 1100 corresponds to a unique virtual domain identifier, which allows concurrent operation of multiple virtual domains (corresponding to multiple tenants) over physical space 1120. As those skilled in the art can appreciate, some of virtual domains 1100 may include a portion of virtual machines 1102-1110, while other virtual domains 1100 may include different virtual machines and different policies than what is shown in FIG. 11.

When a “source” virtual machine sends data to a “destination” virtual machine, a policy corresponding to the two virtual machines describes a logical path on which the data travels (e.g., through a firewall, through an accelerator, etc.). In other words, policies 1103-1113 define how different virtual machines communicate with each other (or with external networks). For example, a policy may define quality of service (QoS) requirements between a set of virtual machines; access controls associated with particular virtual machines; or a set of virtual or physical appliances (equipment) to traverse when sending or receiving data. In addition, some appliances may include accelerators such as compression, IP Security (IPSec), SSL, or security appliances such as a firewall or an intrusion detection system. In addition, a policy may be configured to disallow communication between the source virtual machine and the destination virtual machine.

Virtual domains 1100 are logically overlayed onto physical network 1120, which includes physical entities 1125 through 1188 (hosts, switches, and routers). While the way in which a policy is enforced in the system affects and depends on physical network 1120, virtual domains 1100 are more dependent upon logical descriptions in the policies. As such, multiple virtual domains 1100 may be overlayed onto physical network 1120. As can be seen, physical network 1120 is divided into subnet X 1122 and subnet Y 1124. The subnets are joined via routers 1135 and 1140. Virtual domains 1100 are independent of physical constraints of physical network 1120 (e.g., L2 layer constraints within a subnet). Therefore, a virtual network may include physical entities included in both subnet X 1122 and subnet Y 1124.

In one embodiment, the virtual network abstractions support address independence between different virtual domains 1100. For example, two different virtual machines operating in two different virtual networks may have the same IP address. As another example, the virtual network abstractions support deploying virtual machines, which belong to the same virtual networks, onto different hosts that are located in different physical subnets (includes switches and/or routers between the physical entities). In another embodiment, virtual machines belonging to different virtual networks may be hosted on the same physical host. In yet another embodiment, the virtual network abstractions support virtual machine migration anywhere in a data center without changing the virtual machine's network address and losing its network connection.

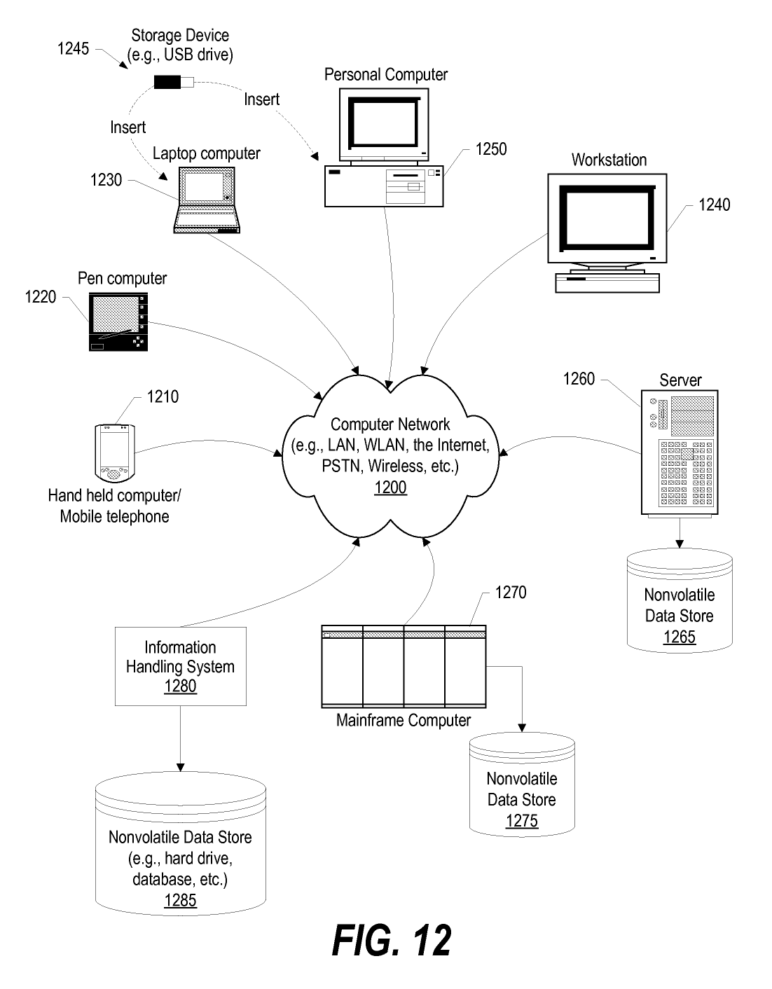

FIG. 12 illustrates information handling system 1200, which is a simplified example of a computer system capable of performing the computing operations described herein. Information handling system 1200 includes one or more processors 1210 coupled to processor interface bus 1212. Processor interface bus 1212 connects processors 1210 to Northbridge 1215, which is also known as the Memory Controller Hub (MCH). Northbridge 1215 connects to system memory 1220 and provides a means for processor(s) 1210 to access the system memory. Graphics controller 1225 also connects to Northbridge 1215. In one embodiment, PCI Express bus 1218 connects Northbridge 1215 to graphics controller 1225. Graphics controller 1225 connects to display device 1230, such as a computer monitor.

Northbridge 1215 and Southbridge 1235 connect to each other using bus 1219. In one embodiment, the bus is a Direct Media Interface (DMI) bus that transfers data at high speeds in each direction between Northbridge 1215 and Southbridge 1235. In another embodiment, a Peripheral Component Interconnect (PCI) bus connects the Northbridge and the Southbridge. Southbridge 1235, also known as the I/O Controller Hub (ICH) is a chip that generally implements capabilities that operate at slower speeds than the capabilities provided by the Northbridge. Southbridge 1235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 1296 and “legacy” I/O devices (using a “super I/O” chip). The “legacy” I/O devices (1298) can include, for example, serial and parallel ports, keyboard, mouse, and/or a floppy disk controller. The LPC bus also connects Southbridge 1235 to Trusted Platform Module (TPM) 1295. Other components often included in Southbridge 1235 include a Direct Memory Access (DMA) controller, a Programmable Interrupt Controller (PIC), and a storage device controller, which connects Southbridge 1235 to nonvolatile storage device 1285, such as a hard disk drive, using bus 1284.

ExpressCard 1255 is a slot that connects hot-pluggable devices to the information handling system. ExpressCard 1255 supports both PCI Express and USB connectivity as it connects to Southbridge 1235 using both the Universal Serial Bus (USB) the PCI Express bus. Southbridge 1235 includes USB Controller 1240 that provides USB connectivity to devices that connect to the USB. These devices include webcam (camera) 1250, infrared (IR) receiver 1248, keyboard and trackpad 1244, and Bluetooth device 1246, which provides for wireless personal area networks (PANs). USB Controller 1240 also provides USB connectivity to other miscellaneous USB connected devices 1242, such as a mouse, removable nonvolatile storage device 1245, modems, network cards, ISDN connectors, fax, printers, USB hubs, and many other types of USB connected devices. While removable nonvolatile storage device 1245 is shown as a USB-connected device, removable nonvolatile storage device 1245 could be connected using a different interface, such as a Firewire interface, etcetera.

Wireless Local Area Network (LAN) device 1275 connects to Southbridge 1235 via the PCI or PCI Express bus 1272. LAN device 1275 typically implements one of the IEEE 802.11 standards of over-the-air modulation techniques that all use the same protocol to wirelessly communicate between information handling system 1200 and another computer system or device. Optical storage device 1290 connects to Southbridge 1235 using Serial ATA (SATA) bus 1288. Serial ATA adapters and devices communicate over a high-speed serial link. The Serial ATA bus also connects Southbridge 1235 to other forms of storage devices, such as hard disk drives. Audio circuitry 1260, such as a sound card, connects to Southbridge 1235 via bus 1258. Audio circuitry 1260 also provides functionality such as audio line-in and optical digital audio in port 1262, optical digital output and headphone jack 1264, internal speakers 1266, and internal microphone 1268. Ethernet controller 1270 connects to Southbridge 1235 using a bus, such as the PCI or PCI Express bus. Ethernet controller 1270 connects information handling system 1200 to a computer network, such as a Local Area Network (LAN), the Internet, and other public and private computer networks.

While FIG. 12 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

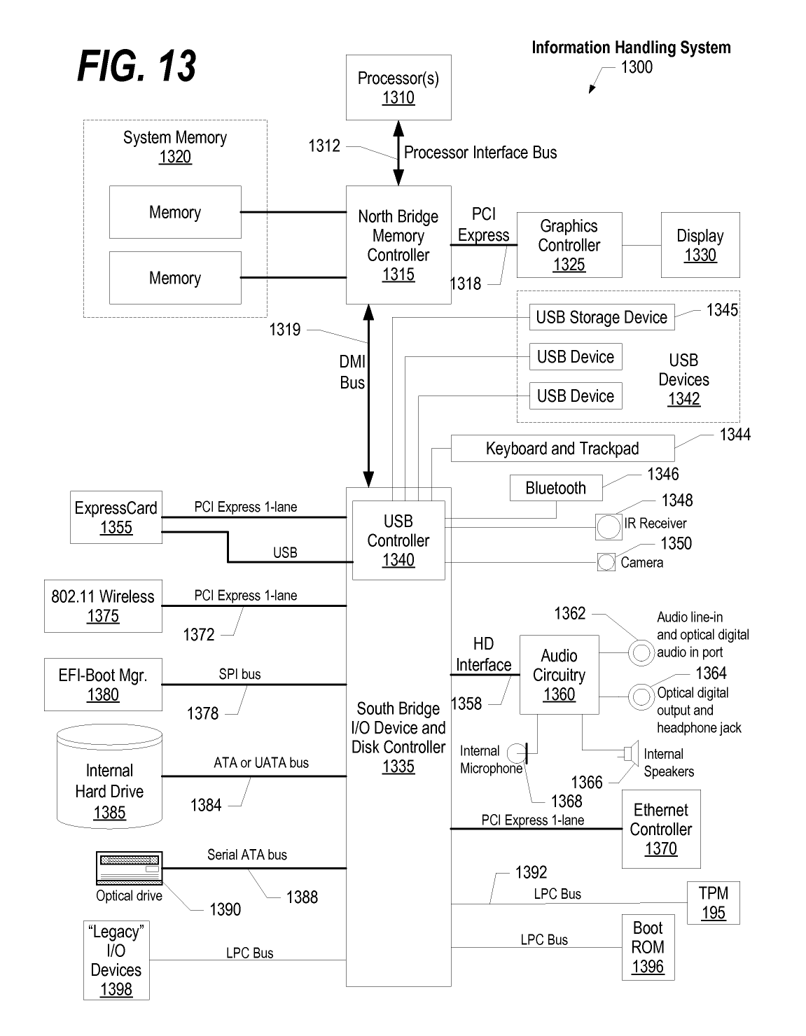

The Trusted Platform Module (TPM 1295) shown in FIG. 12 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 13.

FIG. 13 provides an extension of the information handling system environment shown in FIG. 12 to illustrate that the methods described herein can be performed on a wide variety of information handling systems that operate in a networked environment. Types of information handling systems range from small handheld devices, such as handheld computer/mobile telephone 1310 to large mainframe systems, such as mainframe computer 1370. Examples of handheld computer 1310 include personal digital assistants (PDAs), personal entertainment devices, such as MP3 players, portable televisions, and compact disc players. Other examples of information handling systems include pen, or tablet, computer 1320, laptop, or notebook, computer 1330, workstation 1340, personal computer system 1350, and server 1360. Other types of information handling systems that are not individually shown in FIG. 13 are represented by information handling system 1380. As shown, the various information handling systems can be networked together using computer network 1300. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 13 depicts separate nonvolatile data stores (server 1360 utilizes nonvolatile data store 1365, mainframe computer 1370 utilizes nonvolatile data store 1375, and information handling system 1380 utilizes nonvolatile data store 1385). The nonvolatile data store can be a component that is external to the various information handling systems or can be internal to one of the information handling systems. In addition, removable nonvolatile storage device 1245 can be shared among two or more information handling systems using various techniques, such as connecting the removable nonvolatile storage device 1245 to a USB port or other connector of the information handling systems.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method for managing endpoint address entries that resolve address resolution requests, the method comprising:
receiving an egress data packet at a local module initiated by a virtual network endpoint, the egress data packet including a virtual IP address corresponding to the virtual network endpoint;
determining that an endpoint address entry corresponding to the virtual network endpoint fails to include the virtual IP address;
updating the endpoint address entry with the virtual IP address in response to the determination; and
sending a notification to a distributed policy service in response to updating the endpoint address entry.

2. The method of claim 1 wherein the notification includes the virtual IP address, the method further comprising:
updating a virtual domain endpoint address entry by the distributed policy service, wherein the updating comprises including the virtual IP address and a physical host address in the virtual domain endpoint address entry, the physical host address included in the notification and corresponding to a host system that executes the virtual network endpoint.

3. The method of claim 1 further comprising:
receiving an overlay address resolution request at the distributed policy service from a different local module, the overlay address resolution request corresponding to the virtual network endpoint;
creating, by the distributed policy service, an overlay address resolution reply that includes endpoint address information retrieved from the virtual domain endpoint address entry; and
sending the overlay address resolution reply to different local module.

4. The method of claim 3 further comprising:
receiving, at the different local module, the overlay address resolution reply;
extracting, by the different local module, the endpoint address information from the overlay address resolution reply;
creating, by the different local module, an endpoint address resolution reply that includes the endpoint address information; and
sending, by the different local module, the endpoint address resolution reply to the different virtual network endpoint.

5. The method of claim 1 further comprising:
receiving, at the distributed policy service, an overlay address resolution request from the local module, the overlay address resolution request corresponding to a destination virtual network endpoint;
identifying a virtual network domain that corresponds to the overlay address resolution request;
selecting one or more partial endpoint address entries entry corresponding to the virtual network domain that includes one or more unresolved address mappings;
selecting one or more other local modules that correspond to one or more of the partial endpoint address entries;
sending a reverse address resolution request to the selected one or more other local modules;
receiving a response, at the distributed policy service, from one of the one or more other local modules, the response including endpoint address information corresponding to the destination virtual network endpoint;
storing the endpoint address information in the partial endpoint address entry, the storing resulting in a complete endpoint address entry; and
sending, by the distributed policy service, an overlay address resolution reply that includes address mapping information corresponding to the complete endpoint address entry.

6. The method of claim 1 further comprising:
prior to receiving the egress data packet, detecting, at the local module, a virtual network endpoint activation corresponding to the virtual network endpoint;
creating the endpoint address entry in a local endpoint table in response to detecting the virtual network endpoint activation; and
populating one or more address fields included in the endpoint address entry.

7. The method of claim 1 further comprising:
receiving an address update message at the distributed policy service;
determining an address update type of the address update message;
in response to determining that the address update type is an endpoint virtual IP change corresponding to a different virtual network endpoint, updating a different virtual domain endpoint address entry corresponding to the different virtual network endpoint with a new virtual IP address included in the address update message; and
in response to determining that the address update type is an endpoint physical host address change corresponding to the different virtual network endpoint, updating the different virtual domain endpoint address entry with a new physical host address included in the address update message.

8. The method of claim 1 further comprising:
receiving an address update message at the distributed policy service that corresponds to a physical IP address change of the local module, the address update message including a new physical IP address;
identifying a plurality of different virtual domain endpoint address entries that correspond to the local module; and
updating each of the plurality of different virtual domain endpoint address entries with the new physical IP address.

9. The method of claim 1 wherein the virtual network endpoint corresponds to one of a plurality of virtual domains, and wherein each of the plurality of virtual domains corresponds to an independent virtual address space and is independently managed by one of a plurality of heterogeneous tenants.

10. A method for managing endpoint address entries that are utilized to resolve address resolution request, the method comprising
receiving an egress data packet at a local module initiated by a virtual network endpoint, the egress data packet including a virtual IP address corresponding to the virtual network endpoint;
determining that an endpoint address entry corresponding to the virtual network endpoint fails to include the virtual IP address;
updating the endpoint address entry with the virtual IP address in response to the determination;
sending a notification to a distributed policy service in response to updating the endpoint address entry, wherein the notification includes the virtual IP address and a physical host address corresponding to a host system that executes the virtual network endpoint;
updating, by the distributed policy service, a virtual domain endpoint address entry by including the virtual IP address and the physical host address in the virtual domain endpoint address entry.
